(19) United States
(12) Patent Application Publication
(10) Pub. No.: US 2012/0269140 A1
(43) Pub. Date: Oct. 25, 2012

(54) DOWNLINK CONTROL SIGNALING FOR COORDINATED MULTIPOINT TRANSMISSION

(75) Inventors: Young-Han Nam, Richardson, TX (US); Boon Loong Ng, Richardson, TX (US); Jianzhong Zhang, Plano, TX (US)

(73) Assignee: Samsung Electronics Co., Ltd., Suwon-si (KR)

(21) Appl. No.: 13/452,790

(22) Filed: Apr. 20, 2012

Related U.S. Application Data
(60) Provisional application No. 61/478,830, filed on Apr. 25, 2011.

(51) Int. Cl. H04W 72/04

(52) U.S. Cl. 370/329

(57) ABSTRACT

A base station performs a method for coordinated multipoint (CoMP) transmission to a plurality of user equipments (UEs). The method includes transmitting a first and a second physical downlink control channel (PDCCH) to a user equipment (UE) in a subframe, wherein the first PDCCH has a first downlink control information (DCI) format and the second PDCCH has a second DCI format. The method also includes transmitting a first transport block of at least one CoMP transmission to the UE in the subframe according to the first PDCCH, the at least one CoMP transmission comprising the first transport block from the base station and a second transport block from a second base station, wherein the second transport block is scheduled according to the second PDCCH.

### CROSS-REFERENCE TO RELATED APPLICATION(S) AND CLAIM OF PRIORITY

The present application is related to U.S. Provisional Patent Application No. 61/478,830, filed Apr. 25, 2011, entitled “DOWNLINK CONTROL SIGNALING FOR COORDINATED MULTIPOINT TRANSMISSION”. Provisional Patent Application No. 61/478,830 is assigned to the assignee of the present application and is hereby incorporated by reference into the present application as if fully set forth herein. The present application hereby claims priority under 35 U.S.C. §119(e) to U.S. Provisional Patent Application No. 61/478,830.

### TECHNICAL FIELD

The present application relates generally to wireless communication and, more specifically, to a system and method for downlink control signaling for use with coordinated multipoint transmission.

### BACKGROUND

Coordinated multipoint (CoMP) transmission and reception is discussed in Release 11 of the 3GPP Long Term Evolution (LTE) standard, as described in 3GPP Technical Report No. RP-101425, “Revised SID proposal: coordinated multi-point operation for LTE”. CoMP transmission and reception have been considered for LTE-Advanced as a means to improve the coverage of high data rates, cell-edge throughput, and to increase system throughput.

### SUMMARY

A base station configured for use in a coordinated multipoint (CoMP) transmission system is provided. The base station includes a processor. The processor is configured to transmit a first and a second physical downlink control channel (PDCCH) to a user equipment (UE) in a subframe, wherein the first PDCCH has a first downlink control information (DCI) format and the second PDCCH has a second DCI format. The processor is also configured to transmit a first transport block of at least one CoMP transmission to the UE in the subframe according to the first PDCCH, the at least one CoMP transmission comprising the first transport block from the base station and a second transport block from a second base station, wherein the second transport block is scheduled according to the second PDCCH.

A user equipment capable of receiving a coordinated multipoint (CoMP) transmission from a plurality of base stations is provided. The user equipment includes a processor configured to receive a first and a second physical downlink control channel (PDCCH) from a first base station in a subframe, wherein the first PDCCH has a first downlink control information (DCI) format and the second PDCCH has a second DCI format. The processor is also configured to receive a first transport block of at least one CoMP data transmission in the subframe from the first base station according to the first PDCCH, and receive a second transport block of the at least one CoMP data transmission in the subframe from a second base station according to the second PDCCH.

For use in a base station in a coordinated multipoint (CoMP) transmission system, a method is provided. The method includes transmitting a first and a second physical downlink control channel (PDCCH) to a user equipment (UE) in a subframe, wherein the first PDCCH has a first downlink control information (DCI) format and the second PDCCH has a second DCI format. The method also includes transmitting a first transport block of at least one CoMP transmission to the UE in the subframe according to the first PDCCH, the at least one CoMP transmission comprising the first transport block from the base station and a second transport block from a second base station, wherein the second transport block is scheduled according to the second PDCCH.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A through 1D illustrate different scenarios for CoMP transmissions;

FIG. 1E illustrates an exemplary wireless network, according to an embodiment of this disclosure;

FIG. 1F illustrates a user equipment according to an embodiment of this disclosure;

FIGS. 2A and 2B illustrate eNodeB architectures using two different CoMP scheduling implementations, according to an embodiment of this disclosure;

FIG. 3 illustrates a system and signaling procedure for CoMP scheduling, according to an embodiment of this disclosure;

FIG. 4 illustrates another system and signaling procedure for CoMP scheduling, according to an embodiment of this disclosure;

FIG. 5 illustrates a system and signaling procedure for CoMP scheduling in multiple subframes, according to embodiments of this disclosure;

FIG. 6 illustrates physical downlink shared channel (PDSCH) receptions at a user equipment (UE) that has received a CoMP schedule in a physical downlink control channel (PDCCH), according to an embodiment of this disclosure;

FIG. 7 illustrates PDSCH receptions at a UE that has received a CoMP schedule in a PDCCH, according to another embodiment of this disclosure; and

FIG. 8 illustrates another system and signaling procedure for CoMP scheduling in multiple subframes, according to embodiments of this disclosure.

### DETAILED DESCRIPTION

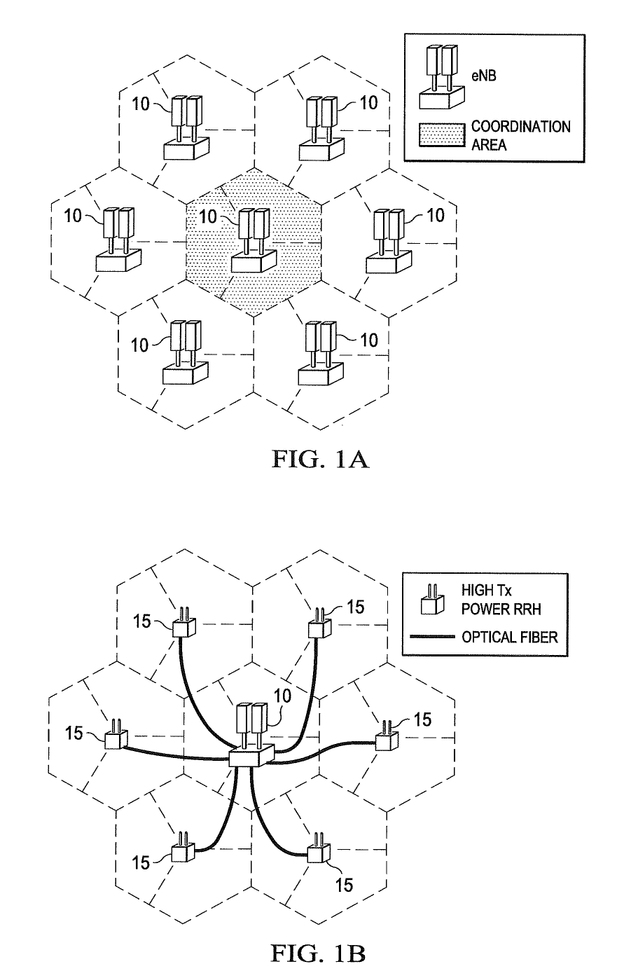

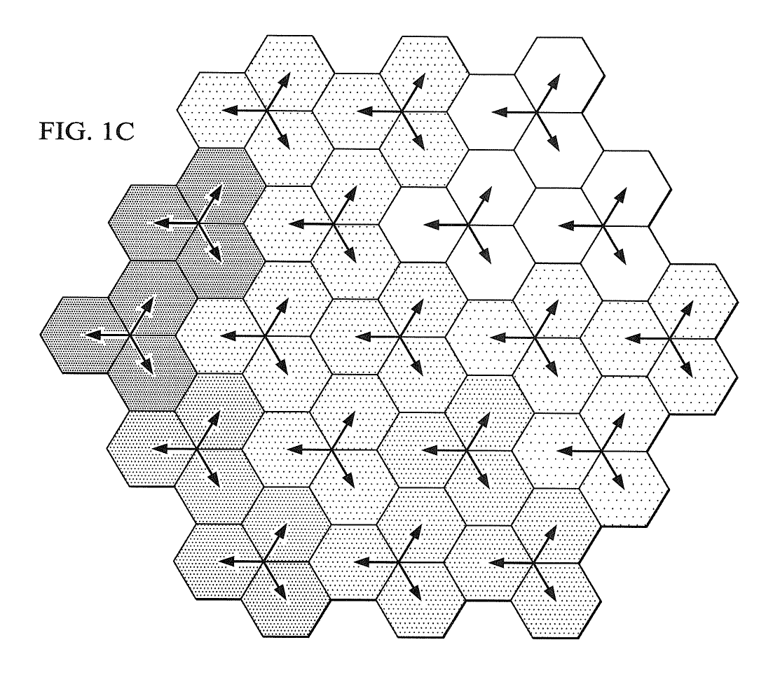

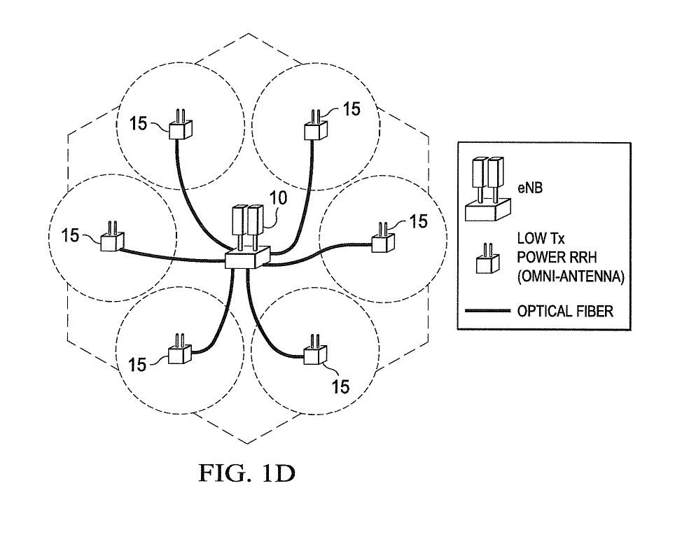

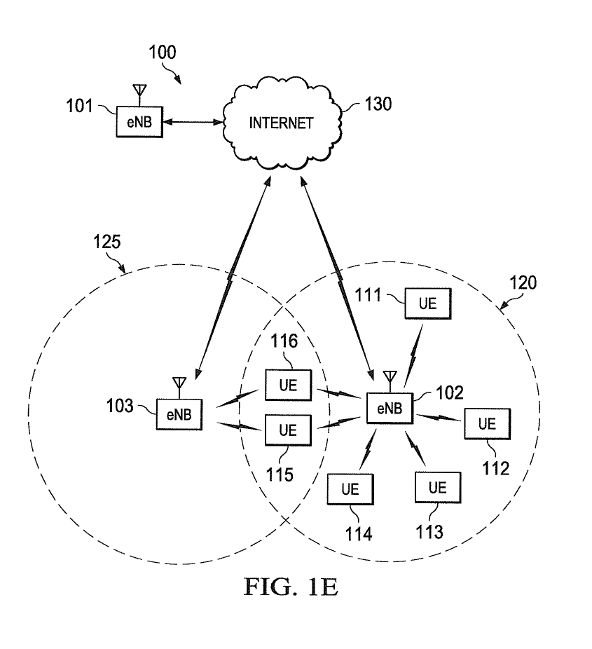

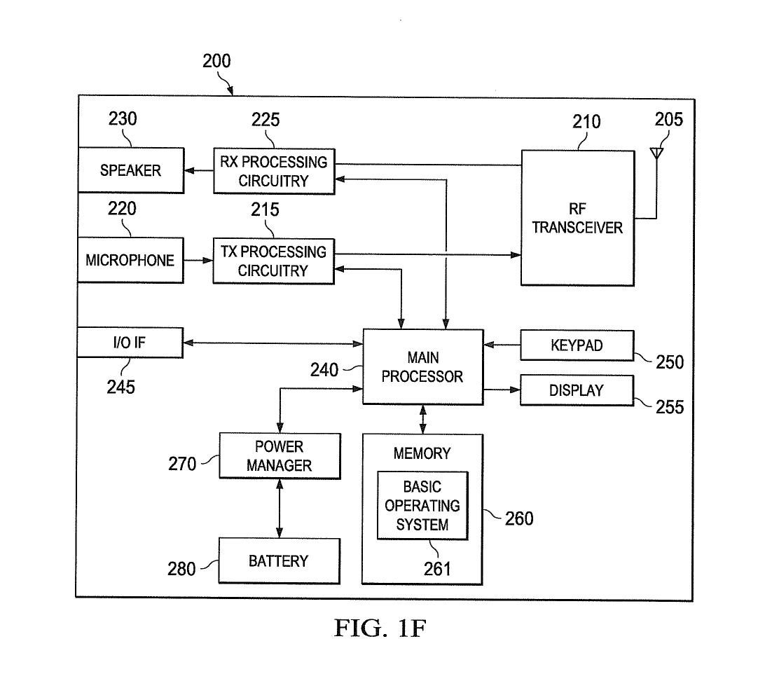

FIGS. 1A through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents and standards descriptions are hereby incorporated into the present disclosure as if fully set forth herein: (i) 3GPP Technical Report No. RP-101425, “Revised SID proposal: coordinated multi-point operation for LTE” (hereinafter “REF1”); (ii) 3GPP Technical Specification No. 36.211, version 10.0.0, “E-UTRA, Physical Channels and Modulation”, (March, 2011) (hereinafter “REF2”); (iii) 3GPP Technical Specification No. 36.212, version 10.0.0, “E-UTRA, Multiplexing and Channel Coding”, (March, 2011) (hereinafter “REF3”); (iv) 3GPP Technical Specification No. 36.213, version 10.0.1, “E-UTRA, Physical Layer Procedures”, (March, 2011) (hereinafter)“REF4”).

As used in this disclosure, coordinated multipoint (CoMP) transmission points (TPs) refer to transmitters associated with a CoMP transmission to a user equipment (UE) in a subframe. TPs may include remote radio heads (RRHs), macro eNodeBs, femto eNodeBs, pico eNodeBs, base stations, and the like. In some embodiments, CoMP TPs have different cell IDs. In other embodiments, CoMP TPs share the same cell IDs.

It is noted that two TPs participating in a CoMP transmission for a UE may transmit downlink signals either in the same component carrier, or in two different component carriers, wherein different component carriers may have different carrier frequencies. In the latter case, the UE may have been RRC configured with at least two component carriers: the primary cell and a secondary cell. Herein, the two terms “cell” and “component carrier” may be used interchangeably.

Document 3GPP TR 36.819.b10, “Coordinated multi-point operation for LTE physical layer aspects”, version 11.0.0, November, 2011 (the contents of which are hereby incorporated into the present disclosure as if fully set forth herein), defines four scenarios for CoMP transmissions, which will now be described.

Scenario 1, illustrated in FIG. 1A, is a homogeneous network comprises a number of eNodeBs 10 with intra-site CoMP.

Scenario 2, illustrated in FIG. 1B, is a homogeneous network with a number of high transmission power RRHs 15. The central entity can coordinate nine (9) cells as a baseline, with the reference layout as in FIG. 1C. In other embodiments, the central entity can coordinate three (3), nineteen (19), or twenty-one (21) cells. Document [R1-110585] (LG Electronics, “Proposal for CoMP Coordination Cell Layout for Scenario 1 and 2”, January 2011) (the contents of which are hereby incorporated into the present disclosure as if fully set forth herein) provides some layout examples.

Scenario 3, illustrated in FIG. 1D, is a heterogeneous network with low power RRHs 15 within the macrocell coverage. In Scenario 3, the transmission/reception points created by the RRHs 15 have different cell IDs as the macro cell. The coordination area includes:

1 cell with N low-power nodes as a starting point; and

3 intra-site cells with 3*N low-power nodes.

The benchmark is non-CoMP Rel. 10 eICIC framework with the different cell ID.

Scenario 4, also illustrated in FIG. 1D, is a network with low power RRHs 15 within the macrocell coverage where the transmission/reception points created by the RRHs have the same cell IDs as the macro cell. The coordination area includes:

1 cell with N low-power nodes as a starting point; and

3 intra-site cells with 3*N low-power nodes.

A CoMP transmission for a UE can be implemented differently depending on how CoMP transmission points share information. Two types of implementation include CoMP joint transmission with same data (CoMP-JTS) and CoMP joint transmission with different data (CoMP-JTD).

In a CoMP-JTS implementation, each of the CoMP transmission points (TPs) use identical information bits (or transport blocks) to transmit to the UE. In this type of implementation, all of the CoMP TPs transmit identical information bits (or transport blocks) to the UE in each scheduled subframe. The information bits are encoded by either the same or different channel encoders at different TPs.

In a CoMP-JTD implementation, the CoMP TPs use different information bits (or transport blocks) to transmit to the UE. In this implementation, the CoMP TPs transmit different information bits (or transport blocks) to the UE in each scheduled subframe. For example, in one embodiment, two CoMP TPs, TP0 and TP1, are associated with a UE. In a subframe, TP0 transmits transport block (or TB1) on layer 0 (using antenna port 7, or AP 7) and TP1 transmits TB2 on layer 1 (using antenna port 8, or AP 8).

This disclosure describes CoMP downlink control signaling methods to facilitate CoMP-JTS, CoMP-JTD, and other types of CoMP transmissions. For CoMP downlink control signaling, two challenges will now be described.

The first challenge is achieving reliable transmission of the physical downlink control channel (PDCCH). CoMP is useful for cell-edge UEs that do not have a very good channel condition (or geometry) from their own primary serving cells (or primary TPs). Thus, it may not be simple for the cell-edge CoMP UEs to reliably decode a high-payload downlink control information (DCI) format (or PDCCH) if the PDCCH is sent over a small number of control channel elements (CCEs), or if the PDCCH code rate is high. In some scenarios, a CoMP UE may not be able to successfully decode a PDCCH even with the highest number of aggregations (e.g., eight aggregations). Thus, it would be beneficial to provide methods to facilitate reliable transmission of the PDCCH to CoMP UEs.

The second challenge is scheduling latency. As the name suggests, CoMP requires coordination between multiple TPs. It may not be possible to design a very efficient scheduling coordination protocol such that the CoMP scheduling coordination can be performed within one transmission time interval (TTI) (e.g., 1 msec for LTE/LTE-A). Therefore, a beneficial CoMP design should take into account scheduling delay.

FIG. 1E illustrates an exemplary wireless network 100, according to embodiments of this disclosure. In certain embodiments, wireless network 100 may represent, include, or be a part of any of the CoMP transmission systems shown in FIGS. 1A through 1D. The embodiment of wireless network 100 illustrated in FIG. 1E is for illustration only. Other embodiments of wireless network 100 could be used without departing from the scope of this disclosure.

In the illustrated embodiment, wireless network 100 includes eNodeB (eNB) 101, eNB 102, and eNB 103. In certain embodiments, eNBs 101-103 may represent any of the eNBs shown in FIGS. 1A through 1D. The eNodeB 101 communicates with eNB 102 and eNB 103 via standardized X2 protocol, via a proprietary protocol, or via Internet protocol (IP) network 130. IP network 130 may include any IP-based network, such as the Internet, a proprietary IP network, or another data network. In embodiments that include RRHs (e.g., the networks shown in FIGS. 1A through 1D), the eNBs (e.g., eNBs 10, 101-103) communicates with the RRHs (e.g., RRHs 15) via standardized X2 protocol, via a proprietary protocol, or via Internet protocol (IP).

Depending on the network type, other well-known terms may be used instead of “eNodeB,” such as “base station” or “access point”. For the sake of convenience, the term “eNodeB” shall be used herein to refer to the network infrastructure components that provide wireless access to remote terminals.

The eNB 102 provides wireless broadband access to a first plurality of user equipments (UEs) within coverage area 120 of eNB 102. The first plurality of UEs includes UE 111, which may be located in a small business; UE 112, which may be located in an enterprise; UE 113, which may be located in a WiFi hotspot; UE 114, which may be located in a first residence; UE 115, which may be located in a second residence; and UE 116, which may be a mobile device, such as a cell phone, a wireless laptop, a wireless PDA, or the like.

For the sake of convenience, the term “user equipment” or “UE” is used herein to designate any remote wireless equipment that wirelessly accesses an eNB, whether the UE is a mobile device (e.g., cell phone) or is normally considered a stationary device (e.g., desktop personal computer, vending machine, etc.). In other systems, other well-known terms may be used instead of “user equipment”, such as “mobile station (MS)”, “subscriber station (SS)”, “remote terminal (RT)”, “wireless terminal (WT)”, and the like.

The eNB 103 provides wireless broadband access to a second plurality of UEs within coverage area 125 of eNodeB 103. The second plurality of UEs includes UE 115 and UE 116. In an exemplary embodiment, eNDs 101-103 may communicate with each other and with UE 111-116 using LTE or LTE-A techniques.

While only six UEs are depicted in FIG. 1E, it is understood that wireless network 100 may provide wireless broadband access to additional UEs. It is noted that UE 115 and UE 116 are located on the edges of both coverage area 120 and coverage area 125. UE 115 and UE 116 each communicate with both eNB 102 and eNB 103 and may be said to be operating in handoff mode, as known to those of skill in the art.

FIG. 1F illustrates a UE 200 according to embodiments of this disclosure. In certain embodiments, UE 200 may represent any of the UEs 111-116 shown in FIG. 1E. The embodiment of UE 200 illustrated in FIG. 1F is for illustration only. Other embodiments of UE 200 could be used without departing from the scope of this disclosure.

UE 200 comprises antenna 205, radio frequency (RF) transceiver 210, transmit (TX) processing circuitry 215, microphone 220, and receive (RX) processing circuitry 225. UE 200 also comprises speaker 230, main processor 240, input/output (I/O) interface (IF) 245, keypad 250, display 255, memory 260, power manager 270, and battery 280.

Radio frequency (RF) transceiver 210 receives from antenna 205 an incoming RF signal transmitted by an eNB of wireless network 100. Radio frequency (RF) transceiver 210 down-converts the incoming RF signal to produce an intermediate frequency (IF) or a baseband signal. The IF or baseband signal is sent to receiver (RX) processing circuitry 225 that produces a processed baseband signal by filtering, decoding, and/or digitizing the baseband or IF signal. Receiver (RX) processing circuitry 225 transmits the processed baseband signal to speaker 230 (i.e., voice data) or to main processor 240 for further processing (e.g., web browsing).

Transmitter (TX) processing circuitry 215 receives analog or digital voice data from microphone 220 or other outgoing baseband data (e.g., web data, e-mail, interactive video game data) from main processor 240. Transmitter (TX) processing circuitry 215 encodes, multiplexes, and/or digitizes the outgoing baseband data to produce a processed baseband or IF signal. Radio frequency (RF) transceiver 210 receives the outgoing processed baseband or IF signal from transmitter (TX) processing circuitry 215. Radio frequency (RF) transceiver 210 up-converts the baseband or IF signal to a radio frequency (RF) signal that is transmitted via antenna 205.

In some embodiments of the present disclosure, main processor 240 is a microprocessor or microcontroller. Memory 260 is coupled to main processor 240. Memory 260 can be any computer readable medium. For example, memory 260 can be any electronic, magnetic, electromagnetic, optical, electro-optical, electro-mechanical, and/or other physical device that can contain, store, communicate, propagate, or transmit a computer program, software, firmware, or data for use by the microprocessor or other computer-related system or method. According to such embodiments, part of memory 260 comprises a random access memory (RAM) and another part of memory 260 comprises a Flash memory, which acts as a read-only memory (ROM).

Main processor 240 executes basic operating system (OS) program 261 stored in memory 260 in order to control the overall operation of mobile station 200. In one such operation, main processor 240 controls the reception of forward channel signals and the transmission of reverse channel signals by radio frequency (RF) transceiver 210, receiver (RX) processing circuitry 225, and transmitter (TX) processing circuitry 215, in accordance with well-known principles.

Main processor 240 is capable of executing other processes and programs resident in memory 260. Main processor 240 can move data into or out of memory 260, as required by an executing process. Main processor 240 is also coupled to power manager 270, which is further coupled to battery 280. Main processor 240 and/or 270 power manager may include software, hardware, and/or firmware capable of controlling and reducing power usage and extending the time between charges of battery 280. In certain embodiments, power manager 270 may be separate from main processor 240. In other embodiments, power manager 270 may be integrated in, or otherwise a part of, main processor 240.

Main processor 240 is also coupled to keypad 250 and display unit 255. The operator of UE 200 uses keypad 250 to enter data into UE 200. Display 255 may be a liquid crystal or light emitting diode (LED) display capable of rendering text and/or graphics from web sites. Alternate embodiments may use other types of displays.

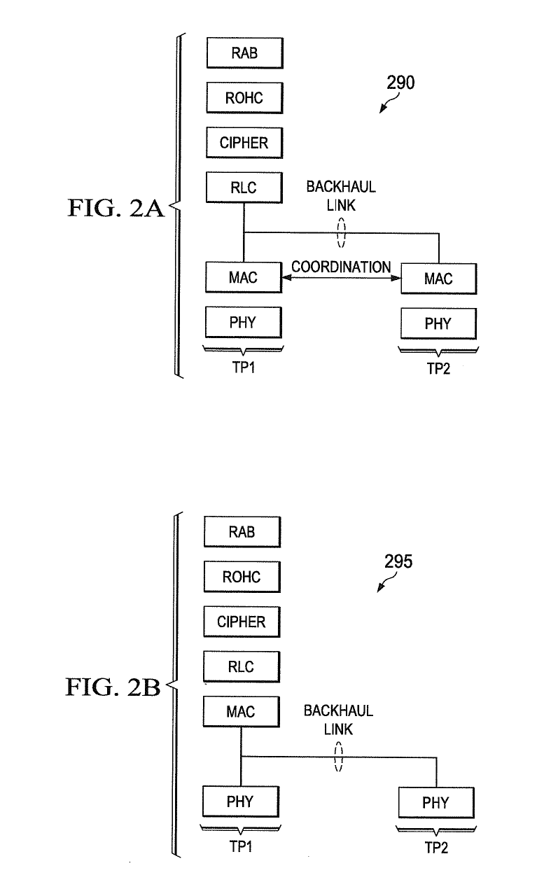

FIGS. 2A and 2B illustrate eNodeB architectures using two different CoMP scheduling implementations. Each transmission point TP1, TP2 may represent one or more of eNBs 101-103 of FIG. 1, or may represent any other suitable eNB. When TPs are geographically separated, the TPs are likely to have separate physical layers (PHYs). However, the scheduling could be implemented using at least two different methods. FIG. 2A illustrates a distributed scheduler 290 with MAC layer coordination. FIG. 2B illustrates a centralized scheduler 295. Depending on whether a centralized scheduler or distributed schedulers are used, which scheduling coordination method is used, and the type of backhaul link that is used, a different CoMP coordination delay would be incurred.

The CoMP coordination delay is the result of multiple factors. For distributed scheduling, the following factors may contribute to the overall CoMP coordination delay:
Channel state information (CSI) exchange delay: For scheduling coordination, it is beneficial that the scheduler for each CoMP TP know every CoMP TP's CSI associated with each CoMP UE.
HARQ-ACK exchange delay: In some situations, the HARQ-ACK (Hybrid Automatic Repeat Request—Acknowledgment) for each CoMP transmission is received at only one TP, and the HARQ-ACK may have to be shared among all the TPs' schedulers.
Scheduling coordination delay: Scheduling coordination may require CoMP TPs to exchange messages with each other, or to transmit messages from one TP to another. Inputs for the scheduling coordination for a CoMP UE could include the CoMP TPs' CSI associated with the CoMP UE, or the HARQ-ACKs received at other TPs.

For centralized scheduling, the following factors may contribute to the overall CoMP coordination delay:
CSI transmission delay: The central scheduler should know every CoMP TP's CSI associated with each CoMP UE.
HARQ-ACK transmission delay: The HARQ-ACK for each CoMP transmission can be received at the TPs, and the HARQ-ACK should be transferred to the central scheduler.
Central Scheduling delay: After collecting the inputs for the central scheduling, the central scheduler takes some time to determine a scheduling strategy for each subframe. Similar to the distributed scheduling, inputs for the central scheduling for a CoMP UE could include the CoMP TPs' CSI associated with the CoMP UE, or the HARQ-ACK received at other TPs.
Scheduling decision transmission delay: The scheduling decision made in the central scheduler should be transferred to the CoMP TPs, which also incurs a protocol delay.

The CoMP coordination delay may have negative impacts on the CoMP performance. For example, scheduling decisions based on an outdated CSI may not provide an expected performance. As another example, in LTE/LTE-A systems, a retransmission may occur eight (8) msec after the initial DL transmission. In some situations, the 8 msec timing is important for correct system operation. The system operation could break down if the 8 msec timing cannot be met because the CoMP coordination delay is too large.

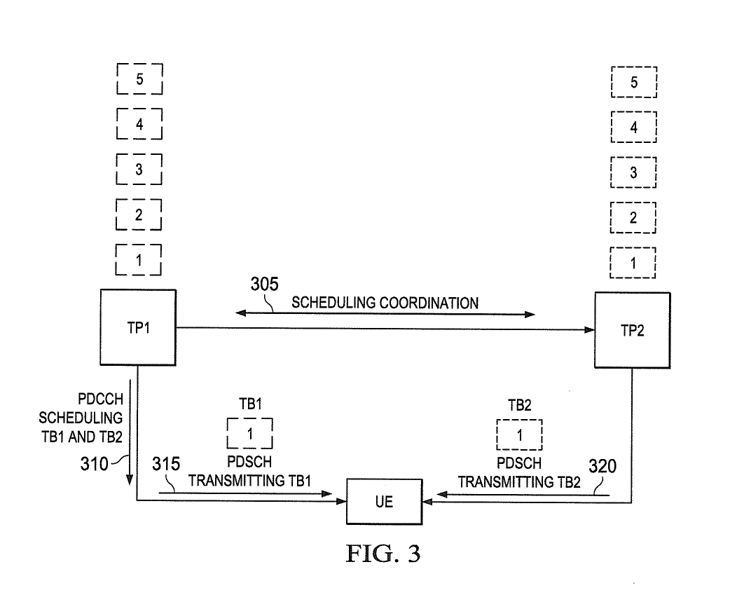

FIG. 3 illustrates a system and signaling procedure for CoMP scheduling, according to an embodiment of this disclosure. In the embodiment shown in FIG. 3, one PDCCH is transmitted per CoMP transmission. FIG. 3 illustrates the signaling procedure among a primary TP (denoted by TP1), a secondary TP (denoted by TP2) and a CoMP UE.

Before each CoMP transmission scheduled in subframe n, one or more higher layers provide information bits (denoted 1 through 5) to each TP to be transmitted over the air to the CoMP UE. The TPs then exchange scheduling information (e.g., physical resource block (PRB) assignment, modulation and coding scheme (MCS), and the like) to be used in transmission to the CoMP UE, as indicated at 305. For example, TP1 and TP2 may assign PRBs #5, #6, and #7 to be used for the CoMP transmission.

In subframe n, a PDCCH is transmitted from at least one of the TPs for scheduling a CoMP transmission of up to two transport blocks (2 TBs) in a set of assigned PRBs to the UE. When the TPs correspond to different cells (as in the embodiment shown in FIG. 3), the TP associated with the primary cell (TP1) transmits the PDCCH, as indicated at 310. In other embodiments, other TPs (e.g., TP2) may transmit the PDCCH.

After the PDCCH has been transmitted, TP1 transmits transport block TB1 on layer 0 (or 1) with demodulation reference signal (DM RS) antenna port (AP) 7 (or 8) in the set of assigned PRBs (as indicated at 315). Likewise, TP2 transmits transport block TB2 on layer 1 (or 0) with DM RS AP 8 (or 7) in the set of assigned PRBs (as indicated at 320). Upon receiving the PDCCH, the UE expects the TB transmissions in the scheduled PRBs, as indicated by the PDCCH.

For the CoMP transmission signaling procedure depicted in FIG. 3, a number of design options for the DCI format for the PDCCH will now be described. In a first option, DCI format 2B, defined in REF3, is used for informing the scheduling information for the UE. When only one TB is transmitted or enabled, the new data indicator (NDI) bit of the disabled TB indicates the DM RS AP, as shown in Table 1 below.

TABLE 1

| New data indicator of the disabled transport block | Antenna port |
|---|---|
| 0 | 7 |
| 1 | 8 |

When two TBs are transmitted or enabled, the two DM RS APs are 7 and 8. Modulation symbols for TB1 are mapped to codeword 0 (or layer 0 whose DM RS AP is 7), and modulation symbols for TB2 are mapped to CW 1 (or layer 1 whose DM RS AP is 8).

In a second option, a new DCI format (denoted as DCI format X) is used for the CoMP transmission. In association with DCI format X, up to two TBs can be assigned. Only contiguous bandwidth (or contiguously numbered PRBs) can be assigned to a UE. For example, resource allocation type 2, defined in Section 7.1.6.3 in REF4, is used for PRB assignment.

In a third option, a new DCI format (denoted as DCI format X1) is created based on DCI format 2B by removing the resource allocation header bit, and replacing the RB assignment field with ┌log₂(N_{RB}^{DL}(N_{RB}^{DL}+1)/2)┐ bits as defined in Section 7.1.6.3 of REF4 (Resource allocation type 2). Herein, N_{RB}^{DL} represents the downlink bandwidth configuration. The ┌log₂(N_{RB}^{DL}(N_{RB}^{DL}+1)/2┐ bits provide the resource allocation (the localized resource allocation type only).

With DCI format X1, the number of information bits used for the RB assignment is reduced. Thus, the total number of bits for the CoMP DCI format is reduced from DCI format 2B. This reduced-size new DCI format helps cell-edge CoMP UEs to receive the CoMP DCI format more reliably. The information elements in the new DCI format X1 are listed below.
Carrier indicator: Zero (0) or three (3) bits depending on the carrier indicator field configuration.
Resource block assignment: ┌log₂(N_{RB}^{DL}(N_{RB}^{DL}+1)/2)┐ bits as defined in Section 7.1.6.3 of REF4 (Resource allocation type 2). The ┌log₂(N_{RB}^{DL}(N_{RB}^{DL}+1)/2)┐ bits provide the resource allocation (the localized resource allocation type only).
TPC command for PUCCH: Two (2) bits as defined in Section 5.1.2.1 of REF4.
Downlink Assignment Index: Two (2) bits. This field is present in time division duplex (TDD) for all uplink-downlink configurations. However, this field typically only applies to TDD operation with uplink-downlink configuration 1-6. This field is not present in frequency division duplex (FDD).
HARQ process number: Three (3) bits for FDD, four (4) bits for TDD.
Scrambling identity: One (1) bit as defined in Section 6.10.3.1 of REF2.

The following additional details apply for transport block 1 in association with the new DCI format X1:
Modulation and coding scheme: Five (5) bits as defined in Section 7.1.7 of REF4.
New data indicator: One (1) bit.
Redundancy version: Two (2) bits.

The following additional details apply for transport block 2 in association with the new DCI format X1:
Modulation and coding scheme: Five (5) bits as defined in Section 7.1.7 of REF4.
New data indicator: One (1) bit.
Redundancy version: Two (2) bits.
If both transport blocks are enabled, the number of layers equals two. Transport block 1 is mapped to codeword (CW) 0, and transport block 2 is mapped to CW 1. Antenna ports 7 and 8 are used for spatial multiplexing.
If one of the transport blocks is disabled, the number of layers equals one. The transport block-to-codeword mapping is performed in such a manner that the enabled TB is mapped to CW 0. The antenna port for single-antenna port transmission is as indicated in Table 1 above.
If the number of information bits in DCI format 2B corresponds to one of the sizes in Table 5.3.3.1.2-1 of REF3, one zero bit shall be appended to DCI format 2B.

In association with a fourth option for a DCI format, a system-wide semi-static bandwidth (BW) partition is used for CoMP and non-CoMP operation, and the CoMP BW is indicated to a CoMP UE by either UE-specific or cell-specific RRC signaling. For example, the radio resource control (RRC) signaling indicates to the CoMP UE that PRBs 0, 1, 2, . . . , 9 are assigned for CoMP. In this situation, the CoMP BW is N_{RB}^{CoMP}=10 PRBs.

In association with the semi-static BW partition, the fourth option for the new CoMP DCI format (denoted as DCI format X2) is created based on DCI format 2B by removing the resource allocation header bit, and replacing the RB assignment field with ┌log₂(N_{RB}^{CoMP}(N_{RB}^{CoMP}+1)/2)┐ bits as defined in Section 7.1.6.3 of REF4 (Resource allocation type 2). The ┌log₂(N_{RB}^{CoMP}(N_{RB}^{CoMP}+1)2)┐ bits provide the resource allocation within the CoMP BW (localized resource allocation type only).

With DCI format X2, the number of information bits used for the RB assignment is further reduced. Thus, the total number of bits for the CoMP DCI format is reduced from new DCI format X1. This reduced-size new DCI format helps cell-edge CoMP UEs to receive the CoMP DCI format more reliably.

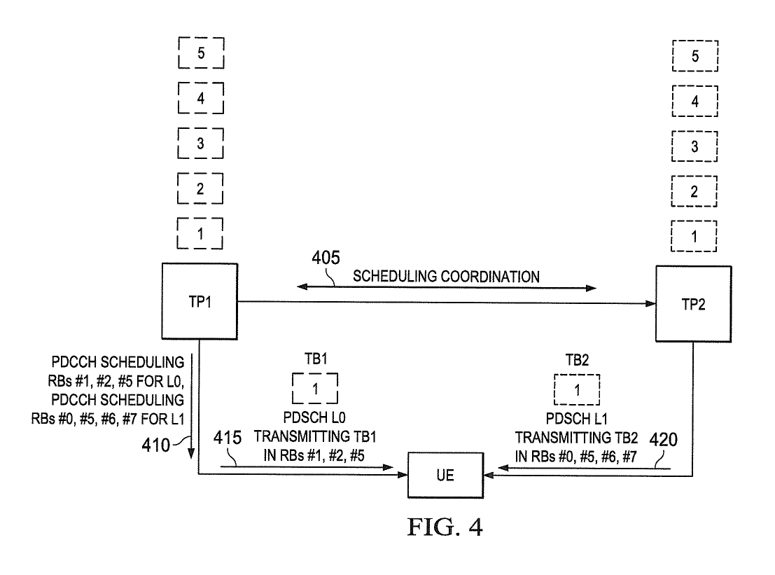

FIG. 4 illustrates another system and signaling procedure for CoMP scheduling, according to an embodiment of this disclosure. In the embodiment shown in FIG. 4, two PDCCHs are transmitted per CoMP transmission. FIG. 4 illustrates the signaling procedure among a CoMP primary TP TP1, a CoMP secondary TP TP2 and a CoMP UE.

Before each CoMP transmission scheduled in subframe n, one or more higher layers provide information bits (denoted 1 through 5) to each TP to be transmitted over the air to the CoMP UE. The TPs then exchange scheduling information (e.g., PRB assignment, MCS, and the like) to be used in transmission to the CoMP UE, as indicated at 405. For example, TP1 and TP2 may assign PRBs #0, #5, #6, and #7 to be used for the CoMP transmission. The exchange of scheduling information between TP1 and TP2 may include a scheduling indication and a scheduling confirmation.

In subframe n, up to two PDCCHs are transmitted from at least one of the TPs. Each PDCCH includes information to schedule one TB in a set of PRBs to the UE. When the TPs correspond to different cells (as in the embodiment shown in FIG. 4), the TP associated with the primary cell (TP1) transmits both PDCCHs, as indicated at 410. In other embodiments, TP1 and TP2 may each transmit a PDCCH.

After the PDCCHs have been transmitted, TP1 transmits TB1 on layer 0 (or 1) with DM RS AP 7 (or 8) in a set of assigned PRBs, as indicated at 415. Additionally or alternatively, TP2 transmits TB2 on layer 1 (or 0) with DM RS AP 8 (or 7) in a set of assigned PRBs, as indicated at 420. Upon receiving the PDCCHs, the UE receives the one or two TB transmissions in associated PDSCHs in the scheduled PRBs, as indicated by the PDCCHs.

For the CoMP transmission signaling procedure depicted in FIG. 4, a number of design options for the DCI format for the PDCCHs may be considered. In association with a first option, the two PDCCHs have substantially identical formats. The new DCI format associated with the first option (denoted as DCI format Y) is characterized by the following features:
Only rank-1 (or single-layer beamforming) transmission can be scheduled. Only one TB can be scheduled.
DCI format Y includes at least one of the three information elements shown in Table 2 below.

TABLE 2

| Information elements in the new DCI format | Contents |
|---|---|
| TB number | 1 or 2 |
| DM RS AP number | 7 or 8 |
| Layer (or CW) number | 0 or 1 |

In one example, a one-bit field in DCI format Y jointly indicates two numbers, the TB number and the DM RS AP number, as shown in Table 3 below.

TABLE 3

| One-bit field jointly | | |
|---|---|---|
| indicating TB number, layer | | DM RS AP |
| number and DM RS AP number | TB number | number |
| 0 | 1 | 7 |
| 1 | 2 | 8 |

In another example, two one-bit fields in DCI format Y separately indicate two numbers. One one-bit field indicates the TB number, and another one-bit field indicates the DM RS AP number, as shown in Table 4 below.

TABLE 4

| One-bit field | | One-bit field | |
|---|---|---|---|
| indicating | TB | indicating | DM RS AP |
| TB number | number | DM RS AP number | number |
| 0 | 1 | 0 | 7 |
| 1 | 2 | 1 | 8 |

In yet another example, a two bit field in DCI format Y jointly indicates the two numbers, TB number and DM RS AP number, as shown in Table 5 below.

TABLE 5

| Two-bit field mapped to index | TB number | DM RS AP number |
|---|---|---|
| 0 (binary ‘00’) | 1 | 7 |
| 1 (binary ‘01’) | 1 | 8 |
| 2 (binary ‘10’) | 2 | 7 |
| 3 (binary ‘11’) | 2 | 8 |

According to a second option, a new DCI format (denoted as DCI format Y1) is created based on DCI format 1 described in REF3, by adding one or two bits for the TB number and DM RS AP number indication, as indicated in Tables 3 through 5. The information elements in the new DCI format Y1 are listed below.
Carrier indicator: Zero (0) or three (3) bits depending on carrier indicator field configuration.
Resource block assignment: For resource allocation type 0 as defined in Section 7.1.6.1 of REF4, ┌N_{RB}^{DL}/P┐ bits provide the resource allocation. For resource allocation type 1 as defined in Section 7.1.6.2 of REF4, ┌log₂(P)┐ bits of this field are used as a header specific to this resource allocation type to indicate the selected resource block subset, one (1) bit indicates a shift of the resource allocation span, and (┌N_{RB}^{DL}/P┐−┌log₂(P)┐−1) bits provide the resource allocation, where the value of P depends on the number of DL resource blocks as indicated in Section 7.1.6.1 of REF4.
TPC command for PUCCH: Two (2) bits as defined in Section 5.1.2.1 of REF4.
Downlink Assignment Index: Two (2) bits. This field is present in TDD for all uplink-downlink configurations. However, this field typically only applies to TDD operation with uplink-downlink configuration 1-6. This field is not present in FDD.
HARQ process number: Three (3) bits for FDD, four (4) bits for TDD.
Modulation and coding scheme: Five (5) bits as defined in Section 7.1.7 of REF4.
New data indicator: One (1) bit.
Redundancy version: Two (2) bits.
TB number and DM RS AP number: One (1) or two (2) bits (e.g., as shown in Tables 3 through 5).

According to a third option, a new DCI format (denoted as DCI format Y2) is created based on DCI format 1A described in REF3, by adding one or two bits for the TB number and DM RS AP number indication, as indicated in Tables 3 through 5.

According to a fourth option, a new DCI format (denoted as DCI format Y3) is created based on DCI format 1A in REF3, by:
adding one or two bits for the TB number and DM RS AP number indication, as indicated in Tables 3 through 5; and
removing the localized/distributed flag, and allowing only localized allocation.

New DCI formats Y2 and Y3 further reduce the DCI payload by allowing contiguous resource allocation only (e.g., resource allocation type 2).

According to another embodiment of the system and signaling procedure depicted in FIG. 4, the two PDCCHs are in two different DCI formats. One DCI format (herein referred to as a full DCI format) provides full scheduling information of one TB scheduling, as described in new DCI formats Y1, Y2, and Y3. The other DCI format (herein referred to a compact DCI format) provides only partial scheduling information of the other TB scheduling. The compact DCI format is constructed based on a full DCI format (e.g., DCI formats Y1, Y2, and Y3). However, the compact DCI format excludes the resource block assignment field found in the full DCI format.

For example, a compact DCI format is constructed from the new DCI format Y1. The compact DCI format includes the following information elements:
Carrier indicator: Zero (0) or three (3) bits depending on carrier indicator field configuration.
TPC command for PUCCH: Two (2) bits as defined in Section 5.1.2.1 of REF4.
Downlink Assignment Index: Two (2) bits. This field is present in TDD for all uplink-downlink configurations. However, this field typically only applies to TDD operation with uplink-downlink configuration 1-6. This field is not present in FDD.
HARQ process number: Three (3) bits for FDD, four (4) bits for TDD.
Modulation and coding scheme: Five (5) bits as defined in Section 7.1.7 of REF4.
New data indicator: One (1) bit.
Redundancy version: Two (2) bits.
TB number and DM RS AP number: One (1) or two (2) bits (e.g., as shown in Tables 3 through 5).

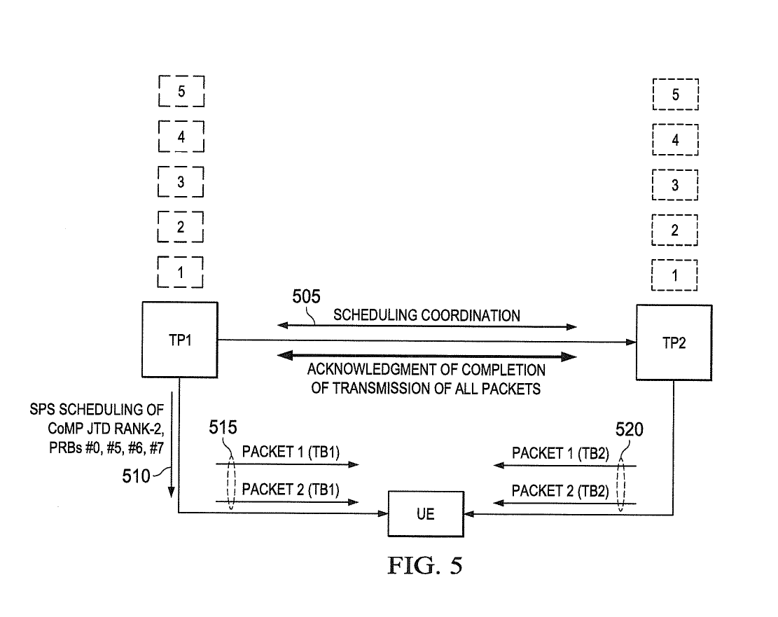

FIG. 5 illustrates a system and signaling procedure for CoMP scheduling in multiple subframes, according to embodiments of this disclosure. In the embodiments shown in FIG. 5, one PDCCH is transmitted to a UE to schedule a burst of CoMP transmissions to the UE. FIG. 5 illustrates the signaling procedure among a CoMP primary TP TP1, a CoMP secondary TP TP2, and a CoMP UE.

Before the burst of CoMP transmissions, one or more higher layers provide information bits (denoted 1 through 5) to each TP to be transmitted over the air to the CoMP UE. The TPs then exchange scheduling information (e.g., PRB assignment, MCS, and the like) to be used in transmission to the CoMP UE, as indicated at 505. For example, TP1 and TP2 may assign PRBs #0, #5, #6, and #7 to be used for the CoMP transmission.

In subframe n, one PDCCH is transmitted by at least one of the TPs. The PDCCH includes information to schedule transmissions of the information bits to the UE in a same (or in a fixed) set of PRBs in a number of scheduled subframes. In each scheduled subframe, up to two TBs are transmitted in the set of PRBs. When the TPs correspond to different cells (as in the embodiment shown in FIG. 5), the TP associated with the primary cell (TP1) transmits the PDCCH, as indicated at 510.

After the PDCCH has been transmitted, in each scheduled subframe, TP1 transmits TB1 on layer 0 (or 1) with DM RS AP 7 (or 8) in the set of assigned PRBs, as indicated at 515. Additionally or alternatively, TP2 transmits TB2 on layer 1 (or 0) with DM RS AP (or 7) in a set of assigned PRBs, as indicated at 520. Upon receiving the PDCCH, in each scheduled subframe, the UE receives the one or two TBs in the set of scheduled PRBs, as indicated by the PDCCH.

In accordance with one embodiment, the CoMP PDSCH subframes scheduled by the PDCCH include a number A of consecutive subframes starting from subframe n. In accordance with another embodiment, the CoMP subframes scheduled by the PDCCH include A consecutive subframes starting from subframe n, n+B, n+2B, . . . , n+kB, and so on, where A, B and k are positive integers. Herein, B represents a period of subframe retransmission.

For either of these embodiments, synchronous HARQ processing may be used. For example, an FDD system is considered, where ‘a’ is a subframe index. In this example, let a ε {0, 1, . . . , A-1}. If a PDSCH transmitted in subframe n+a has not been successfully received at a UE, and if the eNB receives a NACK from the UE in subframe n+a+4, then the retransmission PDSCH is transmitted in subframe n+a+8, without a new DL grant.

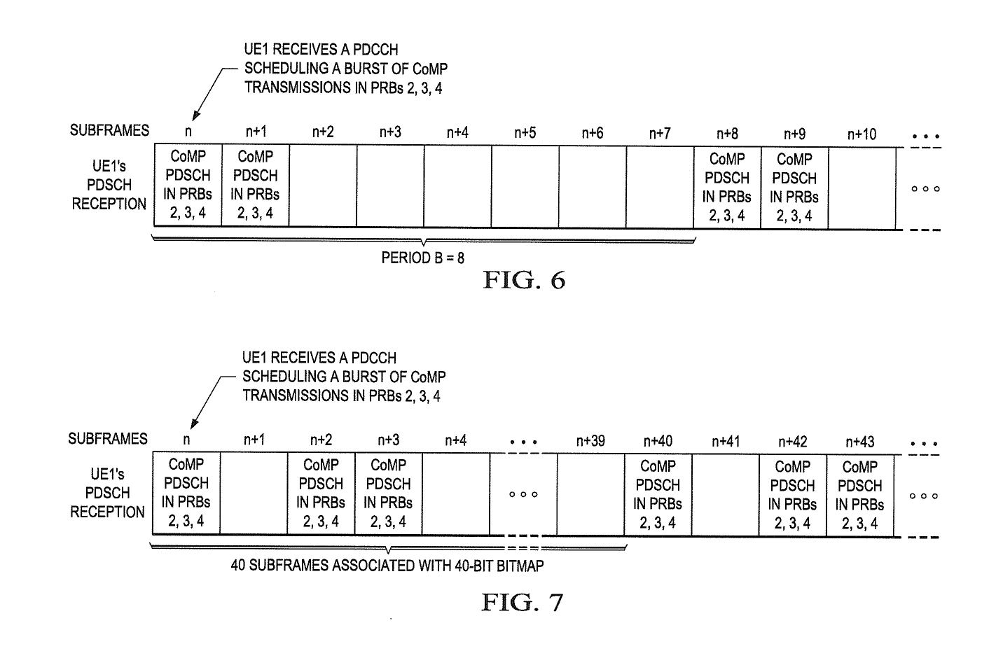

In one example, when A=2 and B=8, the scheduled subframes are n, n+1, n+8, n+8+1, n+16, n+16+1, and so on, as shown in FIG. 6. In other words, two consecutive subframes (A=2) are scheduled out of every eight subframes (B=8). In this example, B=8 is chosen to correspond with the synchronous HARQ timing of 3GPP LTE Rel-8/9/10 with FDD, where a retransmission of a packet transmitted in subframe n occurs in subframe n+8.

In another example, when A=1 and B=8, the scheduled subframes are n, n+8, n+16, and so on.

In another example, when A=1 and B=9, the scheduled subframes are n, n+9, n+18, and so on.

To implement the embodiments depicted in FIG. 5, the following example signaling options are available.

In a first signaling option, the values of A and B are fixed and are not explicitly signaled. For example, UEs may use A=1 and B=8 for deriving the scheduled subframes without any explicit signaling. Thus, the scheduled subframes by the PDCCH are n, n+8, n+16, and so on.

In a second signaling option, A is explicitly signaled, while B has a fixed value and is not explicitly signaled. For example, one of the four (4) possible states shown in Table 6 below is explicitly signaled in a two-bit signal. Thus, the value of A is determined according to the two-bit signal. In another example, one of State 0 and State 1 is explicitly signaled by a one-bit signal.

TABLE 6

| Signal bits | State | A |
|---|---|---|
| 1 or 2 | 0 | 1 |
| 1 or 2 | 1 | 2 |
| 2 | 2 | 3 |
| 2 | 3 | 4 |

The signaling can be conveyed either in the PDCCH or using a MAC/RRC message. For example, in the PDCCH, one or two bits can be appended to a DCI format that can schedule up to two TBs (e.g., DCI format 2B). The one or two appended bits are used to signal the value of A, as shown in Table 6.

Another embodiment of a PDCCH scheduling a burst of CoMP PDSCH transmissions will now be described. In accordance with this embodiment, the CoMP PDSCH subframes scheduled by the PDCCH are indicated by a bitmap (e.g., a bit string comprising 40 bits), where each bit in the bitmap corresponds to a subframe, and the value of each bit indicates whether the subframe is used to transmit a CoMP PDSCH, as shown in FIG. 7. The bitmap can be signaled using a MAC/RRC message. The bitmap can be configured by the eNB to match with the measurement subframe pattern used to specify the time domain measurement resource restriction.

For this type of scheduling, synchronous HARQ processing may be used. For example, an FDD system is considered, where ‘a’ is a subframe index with CoMP PDSCH in the bitmap. If a PDSCH transmitted in subframe n+a (or a) has not been successfully received at a UE, and if the eNB receives a NACK from the UE in subframe n+a+4 (or a+4), then the retransmission PDSCH is transmitted in subframe n+a+8 (or a+8), without a new DL grant.

In one method, a UE monitors the PDCCH used for scheduling the burst of CoMP PDSCHs only in the subframes that can be used to transmit a CoMP PDSCH. This reduces the amount of PDCCH blind decoding that the UE has to perform, especially when a new DCI format with a different size compared to those of the other DCI formats is used for CoMP scheduling. Furthermore, this method can also reduce the probability of false PDCCH detection.

In one method, a UE validates that the received PDCCH schedules or releases a burst of CoMP PDSCH transmissions when a predetermined set of conditions are met (e.g., conditions similar to the conditions validating 3GPP Re1-8/9/10 semi-persistent scheduling (SPS) described in Section 9.2 in REF4). If validation is achieved, the UE considers the received DCI information as a valid semi-persistent activation or release. If validation is not achieved, the UE considers the received DCI format as having been received with a non-matching cyclic redundancy check (CRC). PDCCH validation conditions may be different from those for 3GPP Rel-8/9/10 SPS. A number of design options for PDCCH validation conditions are listed below:

Option A (Validation of PDCCH with CRC scrambled by a new C-RNTI for CoMP):

In accordance with Option A, the CRC parity bits obtained for the PDCCH payload are scrambled with a new type of cell radio network temporary identifier (C-RNTI). For example, the new C-RNTI may be referred to as a CoMP C-RNTI.

The new data indicator (NDI) field is set to ‘0’. For DCI formats that schedule up to 2 TBs (e.g., DCI formats 2, 2A, 2B, 2C, or new DCI formats X, X1, X2 disclosed herein), the NDI bit of each enabled TB is set to ‘0’.

The PDCCH validation code point is similar to that for SPS scheduling. Validation is achieved if all the fields in the associated DCI format are set according to Table 7 or Table 8 below.

For the HARQ process number associated with activations, two options are considered, as shown in Table 7.
Option 1: The HARQ process number of ‘000’ in FDD (or of ‘0000’ in TDD) is included as one condition of validating the burst of CoMP PDSCH transmission.
Option 2: The HARQ process number is not included as one condition of validating the burst of CoMP PDSCH transmission. In accordance with this option, the eNB may set the HARQ process number to a non-zero value, so that it can be used for tracking HARQ processes at the UE.

To reduce the probability of false validation, the UE may assume that the PDCCH for CoMP scheduling is only transmitted in subframes configured for CoMP transmission.

TABLE 7
Special fields for CoMP Semi-Persistent Scheduling Activation PDCCH Validation
(Option A)

| | | | DL grant |
|---|---|---|---|
| | | DL grant | scheduling up to 2 |
| | | scheduling only | TBs (e.g., DCI |
| | | one TB (e.g., DCI | format 2/2A/2B/2C |
| | | format 1/1A, or DCI | or DCI format |
| | DCI format 0 | format Y/Y1/Y2/Y3) | X/X1/X2) |
| TPC command for | set to ‘00’ | N/A | N/A |
| scheduled PUSCH | | | |
| Cyclic shift DM RS | set to ‘000’ | N/A | N/A |
| Modulation and coding | MSB is set to ‘0’ | N/A | N/A |
| scheme and | | | |
| redundancy version | | | |
| HARQ process number | N/A | Alt 1: | Alt 1: |
| | | FDD: set to ‘000’ | FDD: set to ‘000’ |
| | | TDD: set to ‘0000’ | TDD: set to ‘0000’ |
| | | Alt 2: | Alt 2: |
| | | Any values | Any values |
| Modulation and coding | N/A | MSB is set to ‘0’ | For each enabled |
| scheme | | | transport block: |
| | | | MSB is set to ‘0’ |
| Redundancy version | N/A | set to ‘00’ | For each enabled |
| | | | transport block: |
| | | | set to ‘00’ |

TABLE 8
Special fields for CoMP Semi-Persistent Scheduling Release PDCCH
Validation (Option A)

| | DCI format 0 | DCI format 1A |
|---|---|---|
| TPC command for scheduled | set to ‘00’ | N/A |
| PUSCH | | |
| Cyclic shift DM RS | set to ‘000’ | N/A |
| Modulation and coding scheme and | set to ‘11111’ | N/A |
| redundancy version | | |
| Resource block assignment and | Set to all ‘1’s | N/A |
| hopping resource allocation | | |
| HARQ process number | N/A | FDD: set to ‘000’ |
| | | TDD: set to ‘0000’ |
| Modulation and coding scheme | N/A | set to ‘11111’ |
| Redundancy version | N/A | set to ‘00’ |
| Resource block assignment | N/A | Set to all ‘1’s |

Option B (Validation of PDCCH using a unique code point):

In accordance with Option B, the CRC parity bits obtained for the PDCCH payload are scrambled with the Semi-Persistent Scheduling C-RNTI.

The NDI field is set to ‘0’. For DCI formats that schedule up to 2 TBs (e.g., DCI formats 2, 2A, 2B, 2C, or new DCI formats X, X1, X2 disclosed herein), the NDI bit of each enabled TB is set to ‘0’.

The PDCCH validation code point can be similar to that for SPS scheduling. To differentiate between the validation for CoMP scheduling and the validation for SPS, a unique validation code point is designed, as shown in Table 9 and Table 10 below.

For the HARQ process number associated with activations, two options are considered, as shown in Table 9.
Option 1: The HARQ process number of ‘000’ in FDD (or of ‘0000’ in TDD) is included as one condition of validating the burst of CoMP PDSCH transmission.
Option 2: The HARQ process number is not included as one condition of validating the burst of CoMP PDSCH transmission. In accordance with this option, the eNB may set the HARQ process number to a non-zero value, so that it can be used for tracking HARQ processes at the UE.

To reduce the probability of false validation, the UE may assume that the PDCCH for CoMP scheduling is only transmitted in subframes configured for CoMP transmission.

TABLE 9
Special fields for CoMP Semi-Persistent Scheduling Activation PDCCH Validation
(Option B)

| | | | DL grant |
|---|---|---|---|
| | | DL grant | scheduling up to 2 |
| | | scheduling only | TBs (e.g., DCI |
| | | one TB (e.g., DCI | format 2/2A/2B/2C |
| | | format 1/1A, or DCI | or DCI format |
| | DCI format 0 | format Y/Y1/Y2/Y3) | X/X1/X2) |
| TPC command for | set to ‘00’ | N/A | N/A |
| scheduled PUSCH | | | |
| Cyclic shift DM RS | set to ‘111’ | N/A | N/A |
| Modulation and coding | MSB is set to ‘0’ | N/A | N/A |
| scheme and | | | |
| redundancy version | | | |
| HARQ process number | N/A | Alt 1: | Alt 1: |
| | | FDD: set to ‘000’ | FDD: set to ‘000’ |
| | | TDD: set to ‘0000’ | TDD: set to ‘0000’ |
| | | Alt 2: | Alt 2: |
| | | Any values | Any values |
| Modulation and coding | N/A | MSB is set to ‘0’ | For each enabled |
| scheme | | | transport block: |
| | | | MSB is set to ‘0’ |
| Redundancy version | N/A | set to ‘11’ | For each enabled |
| | | | transport block: |
| | | | set to ‘11’ |

TABLE 10
Special fields for CoMP Semi-Persistent Scheduling Release PDCCH
Validation (Option B)

| | DCI format 0 | DCI format 1A |
|---|---|---|
| TPC command for scheduled | set to ‘00’ | N/A |
| PUSCH | | |
| Cyclic shift DM RS | set to ‘000’ | N/A |
| Modulation and coding scheme and | set to ‘11111’ | N/A |
| redundancy version | | |
| Resource block assignment and | Set to all ‘0’s | N/A |
| hopping resource allocation | | |
| HARQ process number | N/A | FDD: set to ‘000’ |
| | | TDD: set to ‘0000’ |
| Modulation and coding scheme | N/A | set to ‘11111’ |
| Redundancy version | N/A | set to ‘00’ |
| Resource block assignment | N/A | Set to all ‘0’s |

Option C (Validation of PDCCH using new DCI formats only):

In accordance with Option C, the PDCCH validation method is as described in Option A or Option B, except that only new DCI formats (e.g. DCI formats X, X1, X2, disclosed herein) can be used for CoMP scheduling.

Option D (A combination of Option A, B and C):

In accordance with Option D, the PDCCH validation method uses a combination of two or more of the methods described in Options A, B, and C.

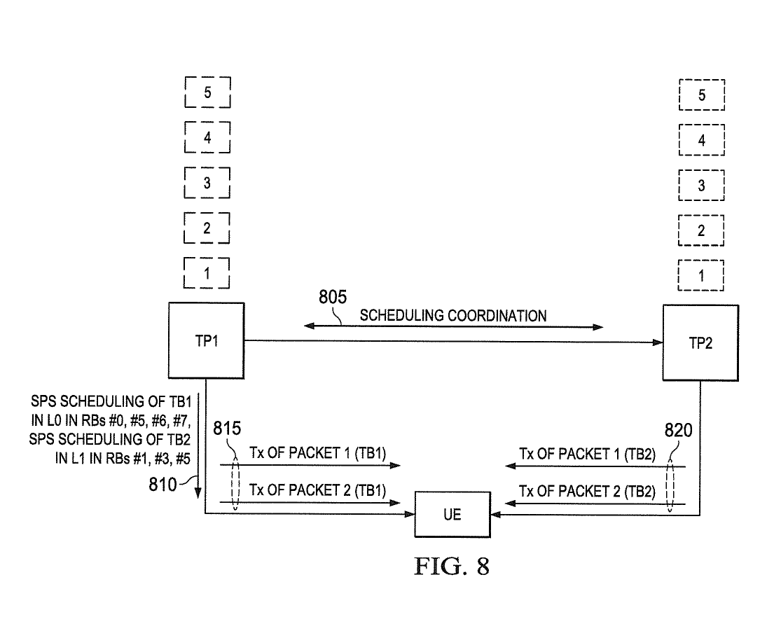

FIG. 8 illustrates another system and signaling procedure for CoMP scheduling in multiple subframes, according to embodiments of this disclosure. In the embodiments shown in FIG. 8, an eNB transmits up to two PDCCHs to a UE to schedule a burst of CoMP transmissions to the UE. FIG. 8 illustrates the signaling procedure among a CoMP primary TP TP1, a CoMP secondary TP TP2, and a CoMP UE.

Before the burst of CoMP transmissions, one or more higher layers provide information bits (denoted 1 through 5) to each TP to be transmitted over the air to the CoMP UE. The TPs then exchange scheduling information (e.g., PRB assignment, MCS, and the like) to be used in transmission to the CoMP UE, as indicated at 805. For example, TP1 may assign PRBs #0, #5, #6, and #7 to be used for the CoMP transmission, while TP2 may assign PRBs #1, #3, and #5 to be used for the CoMP transmission.

In subframe n, up to two PDCCHs are transmitted by at least one of the TPs. The PDCCH(s) include information to schedule transmissions of the information bits to the UE in a same (or in a fixed) set of PRBs in a number of scheduled subframes. Each PDCCH schedules one TB transmission in each scheduled subframe. When the TPs correspond to different cells (as in the embodiment shown in FIG. 8), the TP associated with the primary cell (TP1) transmits both PDCCHs, as indicated at 810.

After the PDCCHs have been transmitted in subframe n, in each scheduled subframe, TP1 transmits TB1 on layer 0 (or 1) with DM RS AP 7 (or 8) in the set of assigned PRBs, as indicated at 815. Additionally or alternatively, TP2 transmits TB2 on layer 1 (or 0) with DM RS AP 8 (or 7) in the set of assigned PRBs, as indicated at 820. Upon receiving the PDCCHs, in each scheduled subframe, the UE receives the one or two TBs in the set of scheduled PRBs, as indicated by the PDCCHs.

In accordance with one embodiment, the CoMP PDSCH subframes scheduled by the PDCCH include a number A of consecutive subframes starting from subframe n. In accordance with another embodiment, the CoMP subframes scheduled by the PDCCH include A consecutive subframes starting from subframe n, n+B, n+2B, . . . , n+kB, so on, where A, B, and k are positive integers. Herein, B represents the period of subframe retransmission.

For either of these embodiments, synchronous HARQ processing may be used. For example, an FDD system is considered, where ‘a’ is a subframe index. In this example, let a ε {0, 1, . . . , A-1}. If a PDSCH transmitted in subframe n+a has not been successfully received at a UE, and if the eNB receives a NACK from the UE in subframe n+a+4, then the retransmission PDSCH is transmitted in subframe n+a+8, without a new DL grant.

In one example, when A=2 and B=8, the scheduled subframes are n, n+1, n+8, n+8+1, n+16, n+16+1, and so on, as shown in FIG. 6. In other words, two consecutive subframes (A=2) are scheduled out of every eight subframes (B=8). In this example, B=8 is chosen to correspond with the synchronous HARQ timing of 3GPP LTE Rel-8/9/10 with FDD, where a retransmission of a packet transmitted in subframe n occurs in subframe n+8.

In another example, when A=1 and B=8, the scheduled subframes are n, n+8, n+16, and so on.

In another example, when A=1 and B=9, the scheduled subframes are n, n+9, n+18, and so on.

To implement the embodiments depicted in FIG. 8, the following example signaling options are available.

In a first signaling option, the values of A and B are fixed and are not explicitly signaled. For example, UEs may use A=1 and B=8 for deriving the scheduled subframes without any explicit signaling. Thus, the scheduled subframes by the PDCCH are n, n+8, n+16, and so on.

In a second signaling option, A is explicitly signaled, while B has a fixed value and is not explicitly signaled. For example, one of the four (4) possible states shown in Table 6 above is explicitly signaled in a two-bit signal. Thus, the value of A is determined according to the two-bit signal. In another example, one of State 0 and State 1 is explicitly signaled by a one-bit signal.

The signaling can be conveyed either in the PDCCH or using a MAC/RRC message. For example, in each of the two PDCCHs, one or two bits can be appended to a DCI format that can schedule one TB (e.g., DCI formats 1 or 1A, or new DCI formats Y, Y1, Y2, Y3 disclosed herein). The one or two appended bits are used to signal the value of A, as shown in Table 6.

Another embodiment of a PDCCH scheduling a burst of CoMP PDSCH transmissions will now be described. In accordance with this embodiment, the CoMP PDSCH subframes scheduled by the PDCCH are indicated by a bitmap (e.g., a bit string comprising 40 bits), where each bit in the bitmap corresponds to a subframe, and the value of each bit indicates whether the subframe is used to transmit a CoMP PDSCH, as shown in FIG. 7. The bitmap can be signaled using a MAC/RRC message. The bitmap can be configured by the eNB to match with the measurement subframe pattern used to specify the time domain measurement resource restriction.

For this type of scheduling, synchronous HARQ processing may be used. For example, an FDD system is considered, where ‘a’ is a subframe index with CoMP PDSCH in the bitmap. If a PDSCH transmitted in subframe n+a (or a) has not been successfully received at a UE, and if the eNB receives a NACK from the UE in subframe n+a+4 (or a+4), then the retransmission PDSCH is transmitted in subframe n+a+8 (or a+8), without a new DL grant.

In one method, a UE monitors the PDCCH used for scheduling the burst of CoMP PDSCHs only in the subframes that can be used to transmit a CoMP PDSCH. This reduces the amount of PDCCH blind decoding that the UE has to perform, especially when a new DCI format with a different size compared to those of the other DCI formats is used for CoMP scheduling.

In one method, a UE validates that the received PDCCH (DCI format 1 or 1A, or new DCI format Y, Y1, Y2, Y3 disclosed herein) schedules or releases a burst of CoMP PDSCH transmissions when the following conditions are met (e.g., conditions similar to the conditions validating 3GPP Re1-8/9/10 semi-persistent scheduling (SPS) described in Section 9.2 in REF4).:
The CRC parity bits obtained for the PDCCH payload are scrambled with the semi-persistent scheduling C-RNTI or a new type of C-RNTI (e.g., CoMP C-RNTI).
The new data indicator (NDI) field is set to ‘0’.

Validation is achieved if all the fields in the associated DCI format are set according to Table 7 or Table 8 above. If validation is achieved, the UE considers the received DCI information accordingly as a valid semi-persistent activation or release. If validation is not achieved, the received DCI format is considered by the UE as having been received with a non-matching CRC.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A base station configured for use in a coordinated multipoint (CoMP) transmission system, the base station comprising:
a processor configured to:
transmit a first and a second physical downlink control channel (PDCCH) to a user equipment (UE) in a subframe, wherein the first PDCCH has a first downlink control information (DCI) format and the second PDCCH has a second DCI format; and
transmit a first transport block of at least one CoMP transmission to the UE in the subframe according to the first PDCCH, the at least one CoMP transmission comprising the first transport block from the base station and a second transport block from a second base station, wherein the second transport block is scheduled according to the second PDCCH.

2. The base station of claim 1, wherein the first and the second transport blocks are transmitted from a same component carrier.

3. The base station of claim 1, wherein the first and the second transport blocks are transmitted from different component carriers.

4. The base station of claim 1, wherein the first PDCCH and the second PDCCH are transmitted to the UE for each CoMP transmission to the UE, and the first and the second DCI formats comprise a resource allocation field having ┌log₂(N_{RB}^{CoMP}(N_{RB}^{CoMP}1)/2)┘ bits where N_{RB}^{CoMP} represents a CoMP bandwidth.

5. The base station of claim 4, wherein the CoMP bandwidth is radio resource control (RRC) configured.

6. The base station of claim 1, wherein the first PDCCH and the second PDCCH are transmitted to the UE for each CoMP transmission to the UE, the first DCI format is the same as the second DCI format, and the DCI formats comprise a one-bit or two-bit field that indicates a transport block number and an antenna port number.

7. The base station of claim 1, wherein the first PDCCH and the second PDCCH are transmitted to the UE for each CoMP transmission to the UE, the first DCI format is different from the second DCI format, and one of the DCI formats comprises a compact format that does not include a resource block assignment field.

8. The base station of claim 1, wherein the first PDCCH and the second PDCCH are transmitted to the UE for a plurality of CoMP transmissions to the UE, and each PDCCH comprises a bitmap where each bit in the bitmap corresponds to a subframe and a value of each bit indicates whether the subframe is used to transmit one of the CoMP transmissions.

9. The base station of claim 1, wherein each of the base station and the second base station comprises one of: an eNodeB and a remote radio head.

10. A user equipment capable of receiving a coordinated multipoint (CoMP) transmission from a plurality of base stations, the user equipment comprising:
a processor configured to:
receive a first and a second physical downlink control channel (PDCCH) from a first base station in a subframe, wherein the first PDCCH has a first downlink control information (DCI) format and the second PDCCH has a second DCI format; and
receive a first transport block of at least one CoMP data transmission in the subframe from the first base station according to the first PDCCH, and receive a second transport block of the at least one CoMP data transmission in the subframe from a second base station according to the second PDCCH.

11. The user equipment of claim 10, wherein the first and the second transport blocks are received from a same component carrier.

12. The user equipment of claim 10, wherein the first and the second transport blocks are received from different component carriers.

13. The user equipment of claim 10, wherein the first PDCCH and the second PDCCH are received at the user equipment for each CoMP transmission received at the user equipment, and the first and the second DCI formats comprise a resource allocation field having ┌log₂(N_{RB}^{CoMP}(N_{RB}^{CoMP}+1)/2)┘ bits where N_{RB}^{CoMP} represents a CoMP bandwidth.

14. The user equipment of claim 13, wherein the CoMP bandwidth is radio resource control (RRC) configured.

15. The user equipment of claim 10, wherein the first PDCCH and the second PDCCH are received at the user equipment for each CoMP transmission received at the user equipment, the first DCI format is the same as the second DCI format, and the DCI formats comprise a one-bit or two-bit field that indicates a transport block number and an antenna port number.

16. The user equipment of claim 10, wherein the first PDCCH and the second PDCCH are received at the user equipment for each CoMP transmission received at the user equipment, the first DCI format is different from the second DCI format, and one of the DCI formats comprises a compact format that does not include a resource block assignment field.

17. The user equipment of claim 10, wherein the first PDCCH and the second PDCCH are received at the user equipment for a plurality of CoMP transmissions received at the user equipment, and each PDCCH comprises a bitmap where each bit in the bitmap corresponds to a subframe and a value of each bit indicates whether the subframe is used to transmit one of the CoMP transmissions.

18. The user equipment of claim 10, wherein each of the first and second transmission points comprises one of: an eNodeB, a base station, and a remote radio head.

19. For use in a base station in a coordinated multipoint (CoMP) transmission system, a method comprising:
transmitting a first and a second physical downlink control channel (PDCCH) to a user equipment (UE) in a subframe, wherein the first PDCCH has a first downlink control information (DCI) format and the second PDCCH has a second DCI format; and
transmitting a first transport block of at least one CoMP transmission to the UE in the subframe according to the first PDCCH, the at least one CoMP transmission comprising the first transport block from the base station and a second transport block from a second base station, wherein the second transport block is scheduled according to the second PDCCH.

20. The method of claim 19, wherein the first and the second transport blocks are transmitted from a same component carrier.

21. The method of claim 19, wherein the first and the second transport blocks are transmitted from different component carriers.

22. The method of claim 19, wherein the first PDCCH and the second PDCCH are transmitted to the UE for each CoMP transmission to the UE, and the first and the second DCI formats comprise a resource allocation field having bits where ┌log₂(N_{RB}^{CoMP}(N_{RB}^{CoMP}+1)/2)┘ bits where N_{RB}^{CoMP} represents a CoMP bandwidth.

23. The method of claim 22, wherein the CoMP bandwidth is radio resource control (RRC) configured.

24. The method of claim 19, wherein the first PDCCH and the second PDCCH are transmitted to the UE for each CoMP transmission to the UE, the first DCI format is the same as the second DCI format, and the DCI formats comprise a one-bit or two-bit field that indicates a transport block number and an antenna port number.

25. The method of claim 19, wherein the first PDCCH and the second PDCCH are transmitted to the UE for each CoMP transmission to the UE, the first DCI format is different from the second DCI format, and one of the DCI formats comprises a compact format that does not include a resource block assignment field.

26. The method of claim 19, wherein the first PDCCH and the second PDCCH are transmitted to the UE for a plurality of CoMP transmissions to the UE, and each PDCCH comprises a bitmap where each bit in the bitmap corresponds to a subframe and a value of each bit indicates whether the subframe is used to transmit one of the CoMP transmissions.

27. The method of claim 19, wherein each of the base station and the second base station comprises one of: an eNodeB and a remote radio head.
